(19) United States
(12) Patent Application Publication
(10) Pub. No.: US 2006/0141428 A1
(43) Pub. Date: Jun. 29, 2006

(54) System and method for monitoring and training users of mobile devices in a network

(75) Inventors: Allan Herrod, Mission Viejo, CA (US); Paul L. Della Maggiora, Durham, NC (US); Shafiq Hajee, Manorville, NY (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/024,385

(22) Filed: Dec. 28, 2004

(51) Int. Cl. G09B 19/00

(52) U.S. Cl. 434/219

(57) ABSTRACT

A system for networking a plurality of user-operated mobile devices includes a network appliance that includes an integrated wireless management system that communicates data to and from a mobile device, a policy service module in the network appliance that is configured to determine from the data whether the mobile device user needs training, and a job service module that is configured to marshal training data if the policy service module determines that the mobile device user needs training.

### TECHNICAL FIELD

The present invention generally relates to systems for networking a plurality of mobile service devices, and more particularly relates to monitoring applications executed in the mobile devices.

### BACKGROUND

Wireless networks are deployed in retail, transportation, logistics, manufacturing, warehousing, and numerous other industries. Wireless networks often include several mobile devices that are configured to carry out numerous transactions by executing suitable applications. Information that pertains to executed transactions can be immediately transmitted from the mobile device to a network appliance for review or further processing. Alternatively, the information can be stored on the mobile device and transmitted to the network appliance at a later time.

As mentioned previously, the mobile devices are typically configured to execute numerous applications. A worker that is assigned to a task using a mobile device may find it difficult to learn to carry out the applications or to troubleshoot problems associated with executing the applications. The mobile devices are often utilized in a place where a technical expert can not immediately assist a worker that is experiencing difficulty. The worker may consequently have difficulty describing a problem that the worker is experiencing with a mobile device once an expert is available to help. Further, the worker may be too busy to ask for help from an expert, and an expert may be too busy to train and monitor the worker to make sure that the problem is solved.

Accordingly, it is desirable to provide ways to accurately monitor performance of a mobile device in a wireless network. In addition, it is desirable to keep track of a plurality of applications executed by the mobile device and to provide training and instructions that detail the proper manner by which the applications should be executed. Furthermore, other desirable features and characteristics of the present invention will become apparent from the subsequent detailed description and the appended claims, taken in conjunction with the accompanying drawings and the foregoing technical field and background.

### BRIEF SUMMARY

A method is provided for training a mobile device user, the mobile device being a component of a network that includes at least one mobile device in communication with a network appliance. The method includes the steps of transmitting data from the mobile device to a policy service module in the network appliance that is configured to determine from the data whether the mobile device user needs training, and supplying training data from the network appliance to the mobile device if the policy service module determines that the mobile device user needs training.

A system is also provided for networking a plurality of user-operated mobile devices. The system includes an integrated wireless management system that communicates data to and from a mobile device, a network appliance that includes a policy service module that is configured to determine from the data whether the mobile device user needs training, and a job service module that is configured to marshal training data if the policy service module determines that the mobile device user needs training.

A program product is also provided for training a mobile device user, the mobile device being a component of a network that includes at least one user-operated mobile device in communication with a network appliance. The program product includes computer readable instructions stored on the network appliance and executable to evaluate data from the mobile device and determine from the data whether the mobile device user needs training, marshal training data if the mobile device user needs training, and transmit the training data to the mobile device.

### BRIEF DESCRIPTION OF THE DRAWINGS

The present invention will hereinafter be described in conjunction with the following drawing figures, wherein like numerals denote like elements, and

FIG. 1 is a diagram that generally illustrates a wireless network;

FIG. 2 is a block diagram that illustrates an exemplary mobile device that is a component of a wireless network;

FIG. 3 is a block diagram that illustrates an exemplary communication path between network devices;

FIG. 4 is a flow chart that illustrates exemplary methods for monitoring an application and automatically training a mobile device user when the application is executed improperly or inefficiently according to an embodiment of the invention;

FIG. 5 is a block diagram that illustrates information collection pathways in a mobile device according to an embodiment of the invention; and

FIG. 6 is a block diagram that illustrates an exemplary communication path between a mobile device and a network appliance, and also illustrates monitoring and training system modules in the network appliance according to an embodiment of the invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

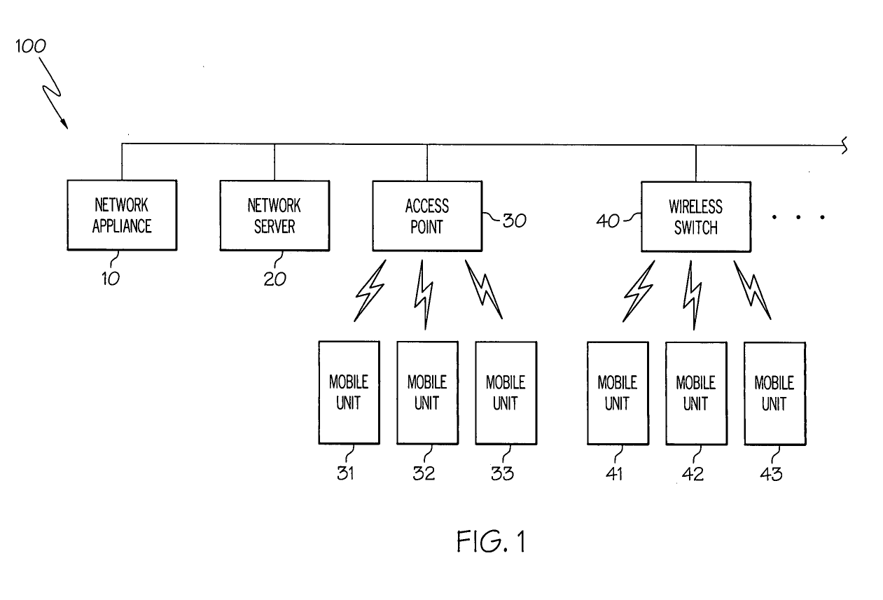

FIG. 1 is a general diagram illustrating an exemplary wireless network 100 that includes a network appliance 10, a network server 20, an access point 30 and a wireless switch 40. Each of the devices 10, 20, 30, 40 is shown as interconnected using a wired portion of the network 100. However, it is understood that the devices 10, 20, 30, 40 can also be wirelessly connected to the network 100. The network 100 can include any number of additional network components and/or devices not illustrated in FIG. 1.

A plurality of mobile devices 31-33 are wirelessly connected to the network 100 by way of the access point 30. The mobile devices 31-33 may be any type of computing or processor-based device including desktop or laptop computers, personal digital assistants, mobile phones, pagers, and scanners. The mobile devices 31-33 and the access point 30 are operable within any type of wireless networking environment such as a wireless local area network (WLAN), and a wireless wide area network (WWAN). Communication between the mobile devices 31-33 and the access point 30 can be accomplished using any wireless protocol such as IEEE 802.11, and Bluetooth. Similarly, mobile devices 41-43 are wirelessly connected to the network 100 via the wireless switch 40. It is understand that the network 100 is only one exemplary embodiment that can be implemented in any wireless arrangement.

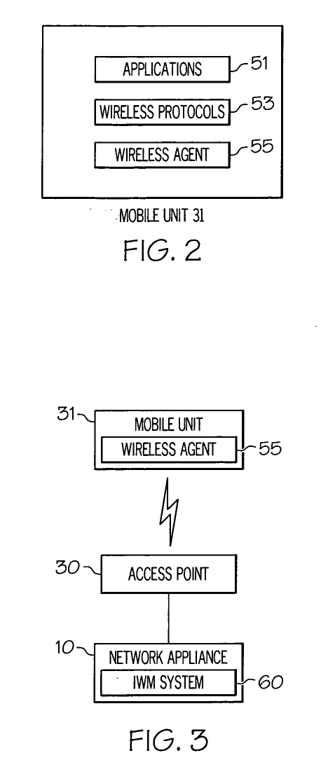

FIG. 2 is a block diagram that illustrates an exemplary mobile device 31 from the network 100. The mobile device 31 includes various software components including applications 51, wireless protocols 53 and a wireless agent 55. Other software components such as an operating system may also be included in the mobile device 31. The applications 51 are software components that allow the mobile device 31 to perform a desired function such as the check out application from the previous example. The wireless protocols 53 are software components that allow the mobile device 31 to communicate with the access point 30 or other mobile devices.

The wireless agent 55 is a software component that includes functionality for the integrated wireless device and network management system. The wireless agent 55 resides on each of the mobile devices in the network 100 and collects information about the mobile device 31 and its performance. The wireless agent 55 can receive inputs from a variety of sources within a mobile device 31 in order to collect information. In one example, the wireless agent 55 monitors the battery level by either querying the operating system or receiving an input from the operating system to determine the current state of the battery life. In a further example the wireless agent 55 queries or receives an input from the wireless protocols 53 that indicates the current transmission bandwidth of the mobile device 31. The wireless agent 55 is consequently the central information conduit in the mobile device 31.

FIG. 3 is a block diagram that illustrates an exemplary communication path between network devices. In this example the communication path is between the mobile device 31, the access point 30 and the network appliance 10. As previously described, the communication path operates bi-directionally so messages can be sent back and forth between the network appliance 10 and the mobile device 31.

The network appliance 10 includes an integrated wireless management (IWM) system 60, the features and functionality of which will now be described in detail. According to an exemplary embodiment, the information that is collected by the wireless agent 55 is communicated to the IWM system 60 on the network appliance 10. The frequency of the transmitted information may vary based on the information that is being transmitted. For example, one of the monitored attributes can be the version of each software application 51 resident on the mobile device 31, and such information may only need to be transmitted when there is a change in the version number. Information regarding other attributes such as battery level and transmission bandwidth typically changes more frequently and the wireless agent 55 can consequently transmit such information almost continuously to the IWM system 60.

The mobile devices 31-33 and 41-43 may only have intermittent connectivity to the network 100. Intermittent connectivity can be the result of various factors including use of the mobile device out of range of its access point or wireless switch, bandwidth limitations, or loss of power to the mobile device. When a mobile device 31 loses contact with the network 100 the wireless agent 55 can store the attributes in a buffer or other storage mechanism for later communication when the mobile device 31 re-establishes connectivity with the network 100. When connectivity is established, the IWM system 60 receives communications from the wireless agent 55 residing on a mobile device 31 and stores information from the communication into a memory in the network appliance 10. A processor is also included in the network appliance 10 and can be configured to compile and present information to a user automatically or as prompted.

Having provided an overview of the network 100, the following is a brief description of an exemplary network operation in the context of a retail outlet having an on- site warehouse. This example provides a general description of interactions between the various network devices. The access point 30 is located in the retail space, and the mobile devices 31-33 are portable check out devices used by clerks in the retail space. The wireless switch 40 is located in the warehouse space with the mobile devices 41-43 being handheld computing devices used by the warehouse personnel.

According to the present example, the network server 20 contains information about products that are sold by the retail outlet. The network server 20 is in contact with the mobile devices 31-33 and 41-43 to keep the information current. For example, the network server contains the current quantity of product A in the retail space and an inventory rule that states a minimum quantity for product A in the retail space. When a clerk uses a mobile device 31 to identify a quantity of product A being purchased the mobile device 31 transmits a message to the access point 30 indicating that the quantity of product A has been sold. The access point 30 then relays this message to the network server 20, which then updates its records by removing that quantity from the current quantity of product in the retail space.

After updating its records, the network server 20 compares the current quantity to the minimum quantity from the inventory rule. If the current quantity is less than the minimum quantity, the network server 20 formats and sends a message to the mobile device 41 via the wireless switch 40. The message indicates to the user of the mobile device 41 that additional quantities of product A need to be moved from the warehouse to the retail space. The user of the mobile device 41 sends an acknowledgment to the message after transferring the additional quantity of product A from the warehouse to the retail space. The network server 20 then updates the information regarding the product A quantities in both the retail space and the warehouse space. Again, it is understood that these network functions are only exemplary and are described to illustrate a set of issues that may be presented in just one setting that involves network control and management.

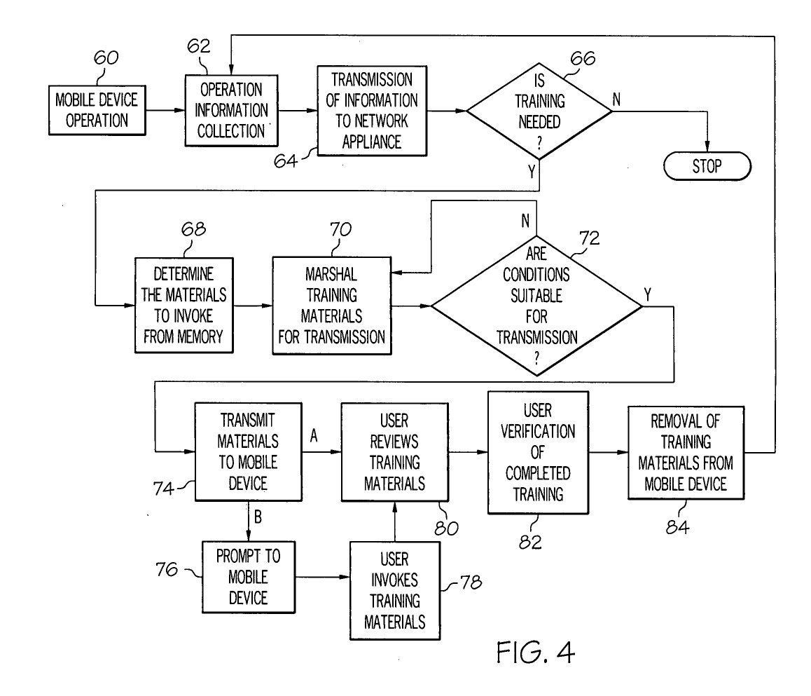

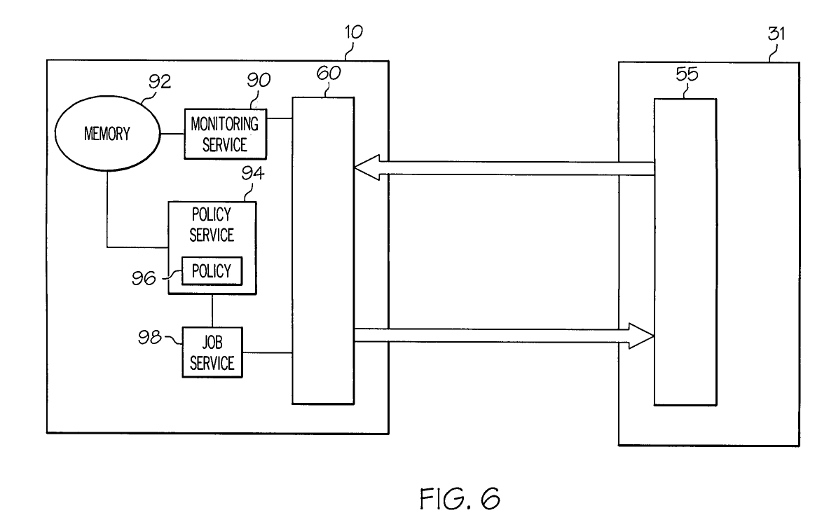

Continuing with the previously-discussed example, an exemplary method of monitoring an application executed by the mobile device, and providing training and instructions that detail the proper manner by which the application should be executed will be discussed with reference to the flow chart of FIG. 4. As the method is discussed, reference will be made to FIG. 6, which is a block diagram representing a mobile device 31, the network appliance 10, and the principle modules and components carrying out the method. Beginning with step 60, a clerk operates a mobile device 31. More particularly, the clerk attempts to have the mobile device 31 execute an application a portable check out device in a retail space. Although numerous applications can be monitored, in the present example the clerk attempts to scan the barcodes of items being sold to a customer.

At step 62, the wireless agent 55 that is included in the check out device 31 collects information about the bar code scanning application. The wireless agent 55 includes a set of profiles to determine the types of information to be collected and transmitted to the IWM system 60, and when such information is to be transmitted. Each profile can indicate the specific attributes to be collected, and the attributes can generally include current AC power line status, main battery level, main battery status, backup battery level, backup battery status, device IP address, device MAC address, DHCP server address, gateway address, network health, network state, memory load, free program memory, total program memory, free storage memory, and total storage memory. Profiles can also indicate static information to be collected from the mobile device 31. Examples of static information include boot loader version, host name, OEM model, OEM version, OS build number, OS version, owner, platform OS model, and device identifier. Furthermore, profiles can also indicate system boot and performance information to be collected such as boot count, total device on seconds, CPU usage, performance measurement interval, performance samples, average thread latency, and average UI-thread latency. Wireless association information to be collected can include wireless BSSID, wireless channel, wireless ESSID, and wireless association status. Profiles can also indicate applications, attributes of the applications, and subsystems executing within the applications that are to be monitored. Exemplary applications and attributes include item shipping confirmations, item receipt confirmations, inventory checks, price checks, battery level, available memory, receiving/transmission bandwidth, wireless signal attributes (e.g., signal quality, signal strength), and wireless throughput attributes (e.g., average link speed, bytes sent, bytes received, current link speed). Exemplary subsystems include a bar code symbol reader module, a smart card reader module, a digital sensor module, a biometric sensor module, a magnetically encoded data reader module, an RFID reader module, and an optical code reader module. These are merely exemplary profiles, and any number of profiles can be implemented to indicate what type of information to collect, and the frequency for each collection.

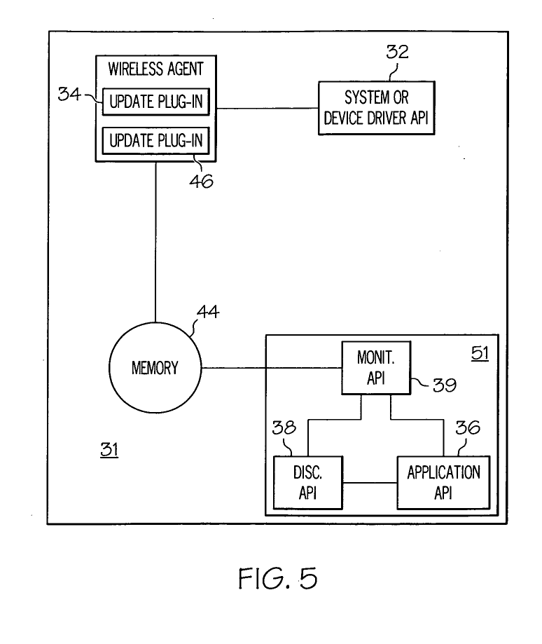

Before continuing with the method set forth in FIG. 4, a brief discussion will be given of exemplary collection pathways between a wireless agent 55 and an application in a mobile device 31, with reference to the block diagram of FIG. 5. In the first information collection pathway, for each set of information that is being monitored a system-level application programming interface (API) 32, such as a device driver API, delivers system- level information to the wireless agent 55. The wireless agent is configured, or supplemented with various plug-in modules 34, to collect and interpret information pertaining to the mobile device 31 and to translate and communicate that and other information to and from the network appliance 10. A significant characteristic of the first pathway is that global, process-independent information is delivered to the wireless agent 55. This is because the system-level API and the network appliance communicate in a process space that is separate from the applications 51 within the mobile device. Even though summary information about application activities can be transferred to the wireless agent 55, the information is primarily system-level and does not report individual steps performed by modules executing within an application 51.

A second information collection pathway enables monitoring of particular functions executed within an application, and an example of such a pathway is illustrated in FIG. 5. Information is collected in an exemplary embodiment by implementing a discriminating API 38 and a monitoring API 39 into the software of each application for which monitoring may be desired. More particularly, when a function is executed within an application 51, the application code 36 calls a discriminating API 38 with data related to the executed application. The discriminating API 38 is a module that is executable within the application 51 and is configured to recognize types of data that are to be monitored. The discriminating API is configured to recognize the data in advance by, for example, a mobile device operator or an IWM operator. When the discriminating API 38 recognizes data, it determines that the application 51 is to be monitored. More particularly, the discriminating API 38 determines that the recognized data produced by an executed function within an application is of a type or class of data that is to be monitored. In an exemplary embodiment, the discriminating API 38 is a dynamic link library (DLL) that is a shared code, and that is mapped into the process space of multiple applications. In other words, any one of multiple applications can call the discriminating API 38, and the discriminating API code is executed within the context of the calling application.

If the discriminating API 38 determines that data will be monitored, the monitoring API 39 stores the data in a memory 44 in the mobile device 31. The API 38 is, like the discriminating API 38, a module that is executable within the application 51. The memory 44 is the central information repository in the mobile device 31 for all the attributes of application-specific information that is monitored from numerous applications. Any particular monitored data set can be collected from the memory 44 and transferred to the network appliance 10 using the wireless agent 55. The wireless agent 55 is configured, or supplemented with various plug-in modules 46, to collect and interpret the information from the memory 44 and to translate and communicate that information to the network appliance 10. Since a user may only want to review as little as one particular application execution, it is advantageous to have the memory 44 disposed within the mobile device 31 in direct communication with the monitoring API 39 rather than having all the application-specific data automatically transferred to the network appliance 10.

Returning now to the method outlined in FIG. 4, after information is collected according to a suitable pathway, the wireless agent 55 in the check out device forwards the information to the network appliance 10 at step 64. The IWM system 60 receives communications from the wireless agent 55, and a mobile device monitoring service module 90 stores information from the communication into a memory 92 in the network appliance 10. As previously discussed, a processor is also included in the network appliance 10 and can be configured to compile and present information to a user automatically or as prompted.

After the network appliance 10 stores information from the check out device 31, a policy service module 94 determines at step 66, based on a predefined policy 96, whether the clerk operating the check out device needs training. For instance, the policy service module 94 may determine that a suboptimal condition exists, such as a barcode scanning rate dropping below a predetermined threshold. If it is determined that all conditions are at an acceptable level, then no further action is required with regard to training. If a suboptimal condition does exist, the policy service module 94 determines the appropriate training that are to be invoked from the database at step 68, and a job service module 98 marshals the training materials for their transmission to the check out device 31 at step 70. In an exemplary embodiment the training materials are relatively large files such as video clips that show the clerk the appropriate procedure for operating the check out device. Since many mobile devices do not have a large memory, it is not practical for numerous training clips to be stored on the mobile device itself. Consequently, the method and assembly of the present invention are beneficial for their ability to allow a mobile device to temporarily access specifically tailored training clips and messages while using little memory.

As soon as the training materials are marshaled by the job service module 98, a decision module 72 determines whether conditions are suitable to transmit the training materials to the check out device 31. Factors that define suitable transmission conditions include whether the check out device 31 is in use or idle, whether communication is or can be established between the network appliance 10 and the check out device 31, and whether there is currently sufficient bandwidth for the transmission to be efficiently carried out. Further, the decision module 72 can be configured to only make the determination that the check out module 31 is idle if a predetermined amount of non-use time has elapsed. The amount of time can vary depending on the type of mobile device and its usage. If conditions are not sufficient for transmission, the training materials remain marshaled and ready for transmission when conditions improve. Transmission occurs at step 74 once conditions are sufficient for transmission to be efficiently carried out.

At this point, either of two pathways can be executed, as indicated with arrows “A” and “B” extending from step 74 in FIG. 4. In the embodiment depicted with arrow “A” the training materials are immediately shown to the check out device user at step 80. When the user is in need of immediate training, the training materials will immediately be shown to the user so the user can correct any problems and return to performing the necessary tasks.

In the embodiment depicted with arrow “B” a message or other prompt is transmitted to the check out device 31 at step 76, indicating that training materials are transmitted to the check out device 31 and ready for viewing. When the clerk operating the check out device 31 is ready, the clerk can enter an acceptance command to invoke the training materials from the check out device memory at step 78. In one embodiment, step 76 of prompting the user can be carried out only one time, every time that a user repeats a function in a manner that caused the initial prompt to be transmitted, or in a periodic sequence over a set time interval until the user enters an acceptance command to invoke the training materials. The training materials are then shown to the user at step 80.

After the clerk completes the training, the clerk logs verification that the training has been completed at step 82. As mentioned previously, an exemplary training procedure is completed by viewing a video clip or a message using a display on the check out module 31, although numerous types of possible training procedures can be executed. Upon logging the verification the check out device 31, immediately or at an appropriate time, removes the training materials from its memory to clear space for other application data or subsequent training materials at step 84.

Finally, additional check out device monitoring can be carried out by restarting the method at step 62. The network appliance 10 can continue to monitor the check out device 31 using this feedback loop to dynamically identify and correct a variety of training issues. Thus, the methods and systems previously described utilize the capabilities of the wireless network 100 to overcome the problem of inadequately trained mobile device users, and optimizes the practicality, applicability, and timeliness of the training delivered to the users. The methods and systems make the network appliance 100 more useful and productive by enhancing the capabilities of the mobile device, as well as the users operating the mobile device, while allowing an administrator to track and enhance training program effectiveness.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of training a mobile device user, the mobile device being a component of a network that comprises at least one mobile device in communication with a network appliance, the method comprising the steps of:
transmitting data from the mobile device to a policy service module in the network appliance that is configured to determine from the data whether the mobile device user needs training; and
marshaling training data from the network appliance for access by the mobile device if the policy service module determines that the mobile device user needs training; and
supplying the training data to the mobile device.

2. The method of claim 1, further comprising the step of:
transmitting a message to the mobile device notifying the user of the training data.

3. The method of claim 2, further comprising the step of:
executing the training data on the mobile device after the user enters a message acceptance command.

4. The method of claim 1, further comprising the step of:
executing the training data on the mobile device immediately after supplying the training data.

5. The method of claim 1, wherein the step of supplying the training data to the mobile device is performed after a decision module in the network appliance determines that the mobile device is idle.

6. The method of claim 5, wherein the step of supplying the training data to the mobile device is performed after the decision module determines that the mobile device has been idle for a predetermined amount of time.

7. The method of claim 1, further comprising the step of:
automatically removing the training materials from the mobile device after the training materials are executed.

8. The method of claim 1, further comprising the step of:
monitoring the mobile device from the network appliance after supplying the training materials to determine whether additional training is needed.

9. A system for networking a plurality of user-operated mobile devices, the system comprising:
a network appliance, comprising:
an integrated wireless management system that transmits and receives data to and from a mobile device;
a policy service module that is configured to evaluate data from the mobile device and determine from the data whether the mobile device user needs training; and
a job service module that is configured to marshal training data for access by the mobile device if the policy service module determines that the mobile device user needs training.

10. The system of claim 9, wherein the network appliance further comprises a memory in which the training data is stored.

11. The system of claim 9, wherein the network appliance is configured to transmit a message to the mobile device notifying the user of the training data.

12. The system of claim 9, wherein the network appliance further comprises a decision module that is configured to determine whether the mobile device is idle, and the network appliance is configured to supply the training data to the mobile device after the decision module in the network appliance determines that the mobile device is idle.

13. The system of claim 12, wherein the network appliance is configured to supply the training data to the mobile device after the decision module determines that the mobile device has been idle for a predetermined amount of time.

14. The system of claim 9, wherein the network appliance is configured to monitor the mobile device after supplying the training materials to the mobile device to determine whether additional training is needed.

15. A system for networking a plurality of user-operated mobile devices, the system comprising:
a network appliance, comprising:
means for transmitting and receiving data to and from a mobile device;
means for evaluating data from the mobile device and determining from the data whether the mobile device user needs training; and
means for marshaling training data for access by the mobile device if the mobile device user needs training.

16. A program product for training a mobile device user, the mobile device being a component of a network that comprises at least one user-operated mobile device in communication with a network appliance, the program product comprising:
computer readable instructions stored on the network appliance and executable to:
evaluate data from the mobile device and determining from the data whether the mobile device user needs training;
marshal training data for access by the mobile device if the mobile device user needs training; and
supply the training data to the mobile device.

17. The program product of claim 16, wherein the computer readable instructions are further executable to transmit a message to the mobile device notifying the user of the training data.

18. The program product of claim 16, wherein the computer readable instructions are further executable to determine whether the mobile device is idle, and to supply the training data to the mobile device once the mobile device is idle.

19. The program product of claim 18, wherein the computer readable instructions are executable to supply the training data if the mobile device has been idle for a predetermined amount of time.

20. The program product of claim 16, wherein the computer readable instructions are further executable to monitor the mobile device after supplying the training materials to the mobile device to determine whether additional training is needed.
